(19) United States
(12) Patent Application Publication
(10) Pub. No.: US 2024/0305937 A1
(43) Pub. Date: Sep. 12, 2024

(54) SYNCHRONOUS BINAURAL USER CONTROLS FOR HEARING INSTRUMENTS

(71) Applicant: Starkey Laboratories, Inc., Eden Prairie, MN (US)

(72) Inventors: Kyle Walsh, Minneapolis, MN (US); Kyle Olson, St. Louis Park, MN (US)

(21) Appl. No.: 18/595,024

(22) Filed: Mar. 4, 2024

Related U.S. Application Data
(60) Provisional application No. 63/488,921, filed on Mar. 7, 2023.

(51) Int. Cl. H04R 25/00

(52) U.S. Cl. CPC H04R 25/552; H04R 2225/55; H04R 2225/61

(57) ABSTRACT

A pair of communicatively coupled hearing instruments that may accept synchronous inputs from a user. The first hearing instrument may receive an input from a user. The second hearing instrument may receive an input from a user and exchange the input with the first hearing instrument over a communication link. The pair of hearing instruments may determine that the user has provided a synchronous input. In response to determining that the user has provided a synchronous input, the pair of hearing instruments may execute a synchronous command.

This application claims the benefit of U.S. Provisional Patent Application No. 63/488,921, filed 7 Mar. 2023, the entire contents of which is incorporated herein by reference.

### TECHNICAL FIELD

This disclosure relates to hearing instruments.

### BACKGROUND

Hearing instruments are devices designed to be worn on, in, or near one or more of a user's ears. Common types of hearing instruments include hearing assistance devices (e.g., “hearing aids”), earbuds, headphones, hearables, cochlear implants, and so on. In some examples, a hearing instrument may be implanted or integrated into a user. Some hearing instruments may communicate with another hearing instrument in the user's other ear. Further, a hearing instrument may receive commands from a user via a user interacting with the hearing instrument.

### SUMMARY

This disclosure describes techniques for controlling hearing instruments through synchronous user input to two hearing instruments that are communicatively coupled. The communicatively coupled hearing instruments may receive synchronous user input and enable the user to utilize synchronous commands to the hearing instruments.

As described herein, a communicatively coupled pair of ear-wearable devices may determine, based on signals from one or more sensors of first ear-wearable device and/or a user response captured by the ear-wearable first device, that a user is interacting with the controls of the first ear-wearable device. The second ear-wearable device may then receive input from the user interacting with the controls of the second ear-wearable device. The pair of ear-wearable devices may then enable the user to modify the settings of the ear-wearable devices by providing input to both ear-wearable devices. The user may provide one manner of input to one of the ear-wearable devices (e.g., pressing and holding a physical button on the device) while providing a different manner of input to the other device (e.g., tapping a physical button on the device).

In one example, this disclosure describes a system comprising a first hearing instrument and a second hearing instrument, wherein the first and second hearing instruments are communicatively coupled, and a processing system included in one or more of the first or second hearing instruments, the processing system including one or more processors implemented in the circuitry, wherein the processing system is configured to obtain, from one or more sensors within the first hearing instrument, first input data from a user of the first hearing instrument and the second hearing instrument, obtain, from one or more sensors within the second hearing instrument, second input data from the user, identify a command based on the first user input and the second user input, and execute the command.

In another example, this disclosure describes a method comprising obtaining, from one or more sensors within a first hearing instrument, first input data from a user of the first hearing instrument, obtaining, from one or more sensors within a second hearing instrument, second input data for the user of the first hearing instrument and the second hearing instrument, identifying, by the first hearing instrument and the second hearing instrument based on the first input data and the second input data, a command, and executing, by the first hearing instrument and second hearing instrument, the command.

In another example, this disclosure describes a non-transitory computer-readable medium, configured to cause one or more processors to obtain, from one or more sensors within a first hearing instrument, first input data, obtain, from one or more sensors within a second hearing instrument, second input data, identify a command based on the first user input and the second user input, and execute the command.

The details of one or more aspects of the disclosure are set forth in the accompanying drawings and the description below. Other features, objects, and advantages of the techniques described in this disclosure will be apparent from the description, drawings, and claims.

### BRIEF DESCRIPTION OF DRAWINGS

FIG. 1 is a conceptual diagram illustrating an example system that includes one or more hearing instruments, in accordance with one or more techniques of this disclosure.

FIG. 2 is a block diagram illustrating example components of a hearing instrument, in accordance with one or more techniques of this disclosure.

FIG. 3 is a flowchart illustrating an example operation in accordance with one or more techniques described in this disclosure.

FIG. 4 is a flowchart illustrating an example operation in accordance with one or more techniques in this disclosure.

### DETAILED DESCRIPTION

A pair of hearing instruments may be communicatively coupled and include one or more sensors that receive user input. For example, the hearing instruments may include one or more inertial measurement units (IMUs), pressure sensors, rocker switches, touch controls that uses skin conductance, accelerometers, or other input device. One of the hearing instruments may receive an input of one kind while the other hearing instrument may receive an input of a different kind. The coupled hearing instruments may enable additional functionality (such as cycling through a series of modes) through the user's input to the pair of ear-wearable devices than if the devices did not allow for synchronous input to both hearing instruments. While the inputs may not always be synchronous in time per se, the pair of hearing instruments may process the inputs as if they had been performed synchronously (hereinafter all such inputs will be referred to as synchronous for the purposes of clarity).

In many cases, hearing instruments may have a wide range of functionality and options that may be adjusted by the user such as volume, active noise cancelation, noise reduction, adaptive vs omnidirectional processing, and other options. However, hearing instruments are often limited in the number of inputs that may be included due to their small physical size (i.e., a device small enough to fit within an ear has a limited amount of physical space for inputs). Further, many users of hearing instruments suffer from disabilities and/or limited mobility that makes it difficult for such users to press small buttons or other input types on a hearing instrument. The ability of the hearing instruments to receive and process synchronous inputs to both hearing instruments increases the range of commands available to the user while not requiring the crowding of the hearing instruments with numerous small input sensors. Further, the synchronous inputs may make providing input to the hearing instruments easier for some users such as those with limited mobility.

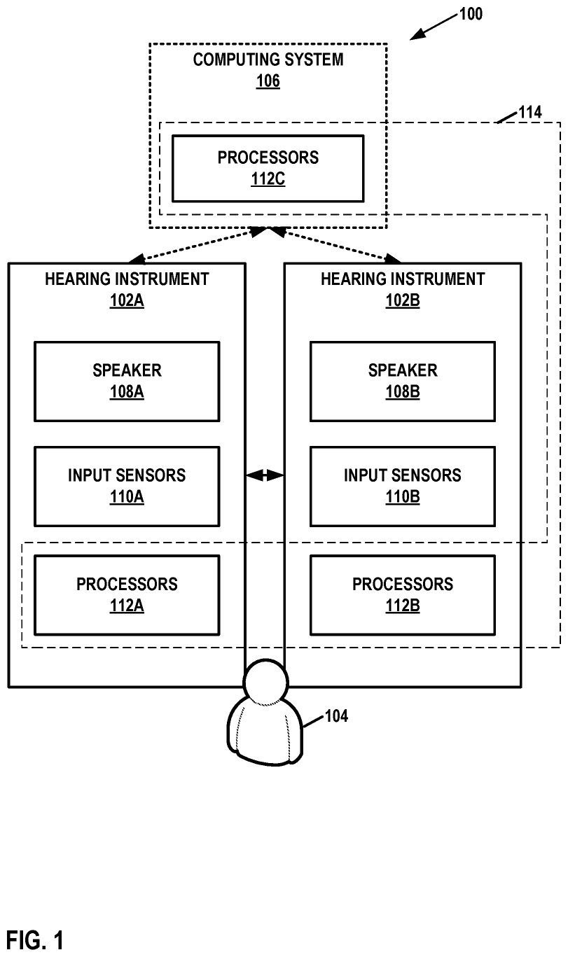

FIG. 1 is a conceptual diagram illustrating an example system 100 that includes hearing instruments 102A and 102B, in accordance with one or more techniques of this disclosure. This disclosure may refer to hearing instruments 102A and 102B collectively, as “hearing instruments 102.” A user 104 may wear hearing instruments 102. In some instances, user 104 may wear a single hearing instrument. In other instances, user 104 may wear two hearing instruments, with one hearing instrument for each ear of user 104.

Hearing instruments 102 may include one or more of various types of devices that are configured to provide auditory stimuli to user 104 and that are designed for wear and/or implantation at, on, near, or in relation to the physiological function of an ear of user 104. Hearing instruments 102 may be worn, at least partially, in the ear canal or concha. One or more of hearing instruments 102 may include behind the ear (BTE) components that are worn behind the cars of user 104. In some examples, hearing instruments 102 include devices that are at least partially implanted into or integrated with the skull of user 104. In some examples, one or more of hearing instruments 102 provides auditory stimuli to user 104 via a bone conduction pathway.

In any of the examples of this disclosure, each of hearing instruments 102 may include a hearing assistance device. Hearing assistance devices include devices that help user 104 hear sounds in the environment of user 104. Example types of hearing assistance devices may include hearing aid devices, Personal Sound Amplification Products (PSAPs), cochlear implant systems (which may include cochlear implant magnets, cochlear implant transducers, and cochlear implant processors), bone-anchored or osseointegrated hearing aids, and so on. In some examples, hearing instruments 102 are over-the-counter, direct-to-consumer, or prescription devices. Furthermore, in some examples, hearing instruments 102 include devices that provide auditory stimuli to user 104 that correspond to artificial sounds or sounds that are not naturally in the environment of user 104, such as recorded music, computer-generated sounds, or other types of sounds. For instance, hearing instruments 102 may include so-called “hearables,” earbuds, earphones, or other types of devices that are worn on or near the cars of user 104. Some types of hearing instruments provide auditory stimuli to user 104 corresponding to sounds from the user's environment and also artificial sounds. In some examples, hearing instruments 102 may include cochlear implants or brainstem implants. In additional examples, hearing instruments 102 may use a bone conduction pathway to provide auditory stimulation. In further examples, one or more of hearing instruments 102 includes a housing or shell that is designed to be worn in the ear for both aesthetic and functional reasons and encloses the electronic components of the hearing instrument. Such hearing instruments may be referred to as in-the-ear (ITE), in-the-canal (ITC), completely-in-the-canal (CIC), or invisible-in-the-canal (IIC) devices. In some examples, one or more of hearing instruments 102 may be behind-the-ear (BTE) devices, which include a housing worn behind the ear that contains all of the electronic components of the hearing instrument, including the receiver (e.g., a speaker). The receiver conducts sound to an earbud inside the ear via an audio tube. In some examples, one or more of hearing instruments 102 are receiver-in-canal (RIC) hearing-assistance devices, which include housings worn behind the cars that contains electronic components and housings worn in the ear canals that contains receivers.

Hearing instruments 102 may implement a variety of features that help user 104 hear better. For example, hearing instruments 102 may amplify the intensity of incoming sound, amplify the intensity of certain frequencies of the incoming sound, translate or compress frequencies of the incoming sound, receive wireless audio transmissions from hearing assistive listening systems and hearing aid accessories (e.g., remote microphones, media streaming devices, and the like), and/or perform other functions to improve the hearing of user 104. In some examples, hearing instruments 102 implement a directional processing mode in which hearing instruments 102 selectively amplify sound originating from a particular direction (e.g., to the front of user 104) while potentially fully or partially canceling sound originating from other directions. In other words, a directional processing mode may selectively attenuate off-axis unwanted sounds. The directional processing mode may help user 104 understand conversations occurring in crowds or other noisy environments. In some examples, hearing instruments 102 use beamforming or directional processing cues to implement or augment directional processing modes.

Hearing instruments 102 reduce may noise by canceling out or attenuating certain frequencies. For example, hearing instruments 102 may use one or more types of passive or active noise cancellation to reduce the volume of incoming noise.

Hearing instruments 102 may help user 104 enjoy audio media, such as music or sound components of visual media, by outputting sound based on audio data wirelessly transmitted to hearing instruments 102. In an example, hearing instruments 102 receive audio data wirelessly transmitted to hearing instruments 102 via one or more wireless radios. Hearing instruments 102 process the received audio data and cause speakers 108 to output sound based on the received audio data.

Hearing instruments 102 may be configured to communicate with each other. For instance, in any of the examples of this disclosure, hearing instruments 102 may communicate with each other using one or more wireless communication technologies. Example types of wireless communication technology include Near-Field Magnetic Induction (NFMI) technology, 900 MHz technology, BLUETOOTH™ technology, WI-FI™ technology, audible sound signals, ultrasonic communication technology, infrared communication technology, inductive communication technology, or other types of communication that do not rely on wires to transmit signals between devices. In some examples, hearing instruments 102 use a 2.4 GHz frequency band for wireless communication. In examples of this disclosure, hearing instruments 102 may communicate with each other via non-wireless communication links, such as via one or more cables, direct electrical contacts, and so on.

As shown in the example of FIG. 1, system 100 may also include a computing system 106. In other examples, system 100 does not include computing system 106. Computing system 106 includes one or more computing devices, each of which may include one or more processors. For instance, computing system 106 may include one or more mobile devices (e.g., smartphones, tablet computers, etc.), server devices, personal computer devices, handheld devices, wireless access points, smart speaker devices, smart televisions, medical alarm devices, smart key fobs, smartwatches, motion or presence sensor devices, smart displays, screen-enhanced smart speakers, wireless routers, wireless communication hubs, prosthetic devices, mobility devices, special-purpose devices, accessory devices, and/or other types of devices. Accessory devices may include devices that are configured specifically for use with hearing instruments 102. Example types of accessory devices may include charging cases for hearing instruments 102, storage cases for hearing instruments 102, media streamer devices, phone streamer devices, external microphone devices, external telecoil devices, remote controls for hearing instruments 102, and other types of devices specifically designed for use with hearing instruments 102.

Actions described in this disclosure as being performed by computing system 106 may be performed by one or more of the computing devices of computing system 106. One or more of hearing instruments 102 may communicate with computing system 106 using wireless or non-wireless communication links. For instance, hearing instruments 102 may communicate with computing system 106 using any of the example types of communication technologies described elsewhere in this disclosure.

In the example of FIG. 1, hearing instrument 102A includes a speaker 108A, input sensors 110A, and a set of one or more processors 112A. Hearing instrument 102B includes a speaker 108B, input sensors 110B, and a set of one or more processors 112B. This disclosure may refer to speaker 108A and speaker 108B collectively as “speakers 108.” This disclosure may refer to input sensors 110A and input sensors 110B collectively as “input sensors 110.” Computing system 106 includes a set of one or more processors 112C. Processors 112C may be distributed among one or more devices of computing system 106. This disclosure may refer to processors 112A, 112B, and 112C collectively as “processors 112.” Processors 112 may be implemented in circuitry and may include microprocessors, application-specific integrated circuits, digital signal processors, artificial intelligence (AI) accelerators, or other types of circuits.

As noted above, hearing instruments 102A, 102B, and computing system 106 may be configured to communicate with one another. Accordingly, processors 112 may be configured to operate together as a processing system 114. Thus, discussion in this disclosure of actions performed by processing system 114 may be performed by one or more processors in one or more of hearing instrument 102A, hearing instrument 102B, or computing system 106, either separately or in coordination. Moreover, it should be appreciated that, in some examples, processing system 114 does not include each of processors 112A, 112B, or 112C. For instance, processing system 114 may be limited to processors 112A and not processors 112B or 112C.

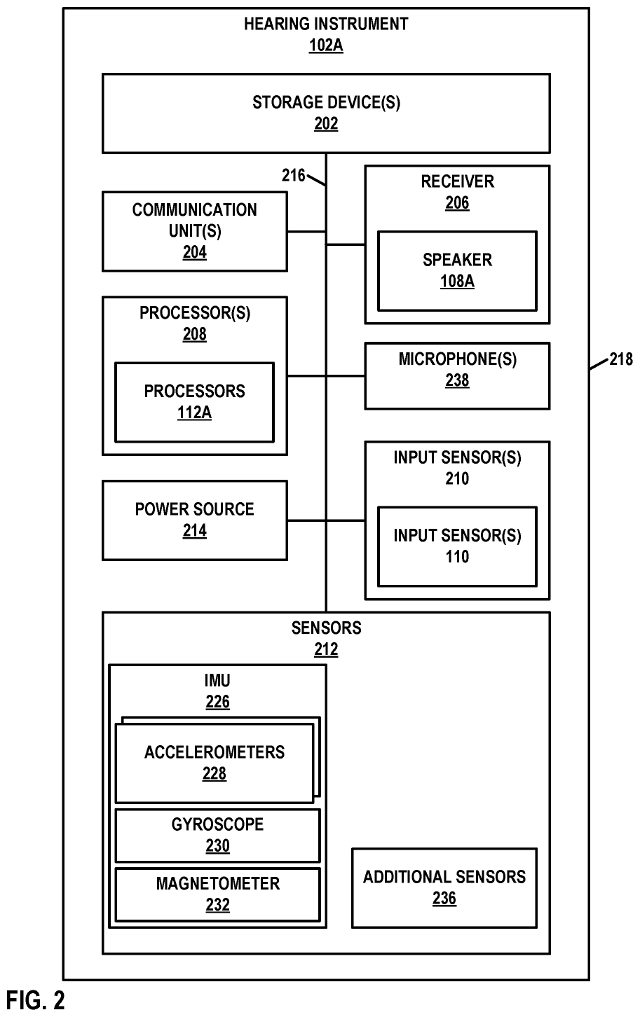

It will be appreciated that hearing instruments 102 and computing system 106 may include components in addition to those shown in the example of FIG. 1, e.g., as shown in the example of FIG. 2. For instance, each of hearing instruments 102 may include one or more additional microphones configured to detect sound in an environment of user 104. The additional microphones may include omnidirectional microphones, directional microphones, own-voice detection sensors, or other types of microphones.

Input sensors 110 may include one or more types of sensors such as rocker switches, physical buttons, capacitive touch interface, resistive touch interface, inductive touch interface, optical sensors, IMU, accelerometer, or other type of input sensor. Hearing instruments 102 may receive input through one or more of input sensors 110. Hearing instruments 102 may receive input from user 104 via one of hearing instruments 102 or both of hearing instruments 102. Additionally, hearing instruments 102 may receive different types of input from user 104 simultaneously. For example, hearing instrument 102A may receive input via a rocker switch while hearing instrument 102B receives input via a touch responsive surface. In additional example, hearing instrument 102A obtains first input data representing user 104 pressing and holding a first touch responsive surface of a first hearing instrument such as hearing instrument 102A while hearing instrument 102B obtains second input data representing user 104 tapping their finger against a second touch responsive surface of a second hearing instrument such as hearing instrument 102B. In another example, hearing instrument 102A obtains input data consistent with user 104 pressing a button on hearing instrument 102A while instrument 102B obtains input data of user 104 pressing a button on hearing instrument 102B. Hearing instruments 102, in response to the input from user 104, activates an active noise canceling mode. In yet another example, hearing instruments 102 obtain input data consistent with user 104 tapping twice on the first of hearing instruments 102 and tapping twice on the second of hearing instruments 102. In a further example, the first of hearing instruments 102 obtains first input data consistent with user 104 pressing and holding down on the first hearing instrument and the second hearing instrument obtains second input data consistent with user 104 tapping the second hearing instrument. In an additional example, one or both of hearing instruments 102 may obtain input data consistent with user 104 tilting their head. In another example, the first of hearing instruments 102 obtains input data consistent with user 104 pressing and holding down on the first of hearing instruments 102 while the second hearing instrument of hearing instruments 102 obtains input data consistent with user 104 pressing and holding down on the second hearing instruments of hearing instruments 102. In a further example, hearing instruments 102 obtain first input and second input that are respectively consistent with the user pressing twice on a first hearing instrument and pressing twice on the second hearing instrument of hearing instruments 102.

Hearing instruments 102 may communicate with each other data regarding user input over one or more communication protocols. In an example, hearing instrument 102A receives input from input sensors 110A. Hearing instrument 102A provides data regarding the input to hearing instrument 102B. Hearing instrument 102B may then determine if user 104 is providing input via input sensors 110B. Responsive to a determination that user 104 is also providing input to input sensors 110B, processors 112B may process the input from user 104 and determine the user's intent. Hearing instrument 102B may communicate with hearing instrument 102A to process the user input and determine the intent of user 104. Processors 112A may additionally process the user input. For example, processors 112A may process the user input and cause hearing instruments 102A to compare a determination regarding the user input with a determination regarding the user input by hearing instrument 102B. Further, hearing instruments 102 may provide the data regarding the user input to computing system 106. Processors 112C may process the user input and provide the results (e.g., a determination regarding the user input) to hearing instruments 102.

Hearing instruments 102 may provide user 104 with the ability to control hearing instruments 102 using synchronous commands. Synchronous commands include commands that are activated by hearing instruments 102 receiving user input to both of hearing instruments 102. As opposed to typical commands executable by hearing instruments 102, hearing instruments 102 execute synchronous commands in response to user input to both of hearing instruments 102. In an example, hearing instruments 102 receive a synchronous input consistent with user 104 interacting with hearing instruments 102 (e.g., user 104 taps a touch-sensitive area on each of hearing instruments 102 within a predetermined period of time). Responsive to the synchronous input, hearing instruments 102 process the input and determine that user 104 has provided a synchronous input. Hearing instruments 102 then execute the synchronous command corresponding to the synchronous input (e.g., activating a noise-canceling mode). The capability of hearing instruments 102 to recognize synchronous commands from user 104 may afford hearing instruments 102 the ability to offer a larger range of commands for user 104 than if hearing instruments 102 did not support synchronous input.

Hearing instruments 102 may enable user 104 to provide a range of synchronous commands to hearing instruments 102. For example, hearing instruments 102 may execute a synchronous command in response to receiving input consistent with user 104 double-tapping the touch surfaces of both of hearing instruments 102. In another example, hearing instruments 102 may execute a synchronous command in response to receiving input consistent with user 104 tapping on one of hearing instruments 102 while swiping on the touch surface of the other of hearing instruments 102. Hearing instruments 102 may differentiate which of hearing instruments 102 receives a particular input to further expand the number of possible types of synchronous input and associated commands. For example, responsive to receiving input consistent with user 104 pressing and holding the touch surface of hearing instrument 102A while swiping on the touch surface of hearing instrument 102B, hearing instruments 102 provide user 104 with a menu of modes that user 104 may select from. In a further example, responsive to input consistent with user 104 pressing and holding the touch surface of hearing instrument 102B while swiping on the touch surface of hearing instrument 102A, hearing instruments 102 cycle through a series of directional audio settings. As illustrated in the prior examples, hearing instruments 102 may differentiate which of hearing instruments 102 receives a particular input and provide a wider range of synchronous commands to user 104.

Hearing instruments 102 may enable user 104 to provide sequential inputs to give a command to hearing instruments 102. Hearing instruments 102 may register the order in which input is received to determine the associated command. For example, hearing instruments 102 may execute one command in response to receiving input consistent with a user tapping the side of hearing instrument 102A and then swiping the side of hearing instrument 102B, but execute a different command if hearing instruments 102 receive input consistent with user 104 first swiping the side of hearing instrument 102B and then tapping the side of hearing instrument 102A. In an example, the first of hearing instruments 102 obtains third input data from the one or more sensors within the first hearing instrument. Hearing instruments 102 then determine that user 104 has ceased interacting with the first hearing instrument before the second of hearing instruments 102 obtains fourth input data from the one or more sensors within the second hearing instrument of hearing instruments 102. Based on the determination that user 104 has ceased interacting with the first hearing instrument before obtaining the fourth input data, hearing instruments 102 identify a second command and execute the second command.

Hearing instruments 102 may wait a predefined (e.g., user-defined) period of time before determining whether user 104 has provided a synchronous input and/or determining whether a synchronous command was received. Hearing instruments 102 may determine whether the predefined period of time has elapsed before identifying a command during which the processing system waits before determining whether a command was given by user 104. Hearing instruments 102 may use the predefined period of time to compensate for transmission delays resulting from communications between hearing instruments 102 (e.g., use the predetermined period of time as time delay to compensate for a transmission delay). In an example, hearing instruments 102 are configured to wait 10 seconds after starting to generate vibration before determining whether input has been received from user 104. Hearing instruments 102 may use the 10 second delay to give user 104 time to provide input to hearing instruments 102. Further, hearing instruments 102 may use the delay to compensate for the time necessary to process user input data and provide the user input data to the other of hearing instruments 102 (e.g., the time needed to process data for transmission, transmission time, and the time needed for processors 112 to process received data). Additionally, hearing instruments 102 may use the predefined time delay to provide user 104 with a longer period of time to input a synchronous input. Such a time delay may be of great use to users with limited mobility and/or disabilities that have reduced motor control. Without a delay between receiving inputs and determining a command, hearing instruments 102 may be unable to recognize synchronous commands requested by user 104. As a result, user 104 may become frustrated with being unable to provide commands to hearing instruments 102 when there is no time delay. Hearing instruments 102 may additionally utilize communication methods that reduce transmission delays such as physical wire connections, high power wireless transmission equipment, and/or low latency wireless transmission protocols. In an example, a command executed by hearing instruments 102 is a first command, and the first user input data and the second user input data are data regarding a previous synchronous input. Hearing instruments 102 modify, based on the data regarding the previous synchronous input, the predetermined period of time. Hearing instruments 102 obtain third input data from user 104 from one or more sensors within the first hearing instrument of hearing instrument 102. Hearing instruments 102 determine that the modified predetermined period of time has elapsed after obtaining the third input data and without obtaining fourth input data from the one or more sensors within the second hearing instrument of hearing instruments 102. Based on the determination that the modified predetermined period of time has elapsed after obtaining the third input data and without obtaining the fourth input data from the one or more sensors within the second hearing instrument, hearing instruments 102 execute the second command.

Hearing instruments 102 may determine whether to execute a second command. In an example, hearing instruments 102 obtain third input data from input sensors 110A of a first hearing instrument such as hearing instrument 102A. Hearing instruments 102 determine that user 104 has ceased interacting with hearing instruments 102A before obtaining fourth input data from one or more of input sensors 110B of a second hearing instrument such as hearing instrument 102B. Hearing instruments 102 identify, based on the determination that user 104 has ceased interacting with hearing instrument 102A before obtaining the fourth input data, a second command. Hearing instruments 102 execute the second command.

Hearing instruments 102 may execute non-synchronous commands. For example, hearing instruments 102 may execute a non-synchronous command after executing a first synchronous command. In another example, a synchronous command is a first command and hearing instruments 102 determine that only one of third input data or further input data has been obtained from hearing instruments 102, where the first input data and the second input data are input data associated with the synchronous command. Hearing instruments 102 identify a non-synchronous command based on which of the third input data or the fourth input data has been obtained, where the non-synchronous command is a second command where input data from only one of the first hearing instrument and the second hearing instrument has obtained. Hearing instruments 102 execute the non-synchronous command.

FIG. 2 is a block diagram illustrating example components of hearing instrument 102A, in accordance with one or more aspects of this disclosure. Hearing instrument 102B may include the same or similar components of hearing instrument 102A shown in the example of FIG. 2. Thus, the discussion of FIG. 2 may apply with respect to hearing instrument 102B. In the example of FIG. 2, hearing instrument 102A includes one or more communication units 204, a receiver 206, one or more processors 208, input sensor(s) 210, one or more microphones 238, a set of sensors 212, a power source 214, one or more communication channels 216, and one or more storage devices 240. Communication channels 216 provide communication between communication unit(s) 204, receiver 206, processor(s) 208, sensors 212, microphone(s) 238, and storage devices 240. Components 204, 206, 208, 210, 212, 216, 238, and 240 may draw electrical power from power source 214.

In the example of FIG. 2, each of components 204, 206, 208, 210, 212, 214, 216, 238, and 240 are contained within a single housing 218. For instance, in examples where hearing instrument 102A is a BTE device, each of components 204, 206, 208, 210, 212, 214, 216, 238, and 240 may be contained within a behind-the-ear housing. In examples where hearing instrument 102A is an ITE, ITC, CIC, or IIC device, each of components 204, 206, 208, 210, 212, 214, 216, 238, and 240 may be contained within an in-ear housing. However, in other examples of this disclosure, components 204, 206, 208, 210, 212, 214, 216, 238, and 240 are distributed among two or more housings. For instance, in an example where hearing instrument 102A is a RIC device, receiver 206, one or more of microphones 238, and one or more of sensors 212 may be included in an in-ear housing separate from a behind-the-ear housing that contains the remaining components of hearing instrument 102A. In such examples, a RIC cable may connect the two housings.

Furthermore, in the example of FIG. 2, sensors 212 include an inertial measurement unit (IMU) 226 that is configured to generate data regarding the motion of hearing instrument 102A. IMU 226 may include a set of sensors. For instance, in the example of FIG. 2, IMU 226 includes one or more accelerometers 228, a gyroscope 230, a magnetometer 232, combinations thereof, and/or other sensors for determining the motion of hearing instrument 102A. Furthermore, in the example of FIG. 2, hearing instrument 102A may include one or more additional sensors 236. Additional sensors 236 may include a photoplethysmography (PPG) sensor, blood oximetry sensors, blood pressure sensors, electrocardiograph (EKG) sensors, body temperature sensors, electroencephalography (EEG) sensors, environmental temperature sensors, environmental pressure sensors, environmental humidity sensors, skin galvanic response sensors, and/or other types of sensors. In other examples, hearing instrument 102A and sensors 212 may include more, fewer, or different components.

Storage device(s) 240 may store data. Storage device(s) 240 may include volatile memory and may therefore not retain stored contents if powered off. Examples of volatile memories may include random access memories (RAM), dynamic random access memories (DRAM), static random access memories (SRAM), and other forms of volatile memories known in the art. Storage device(s) 240 may include non-volatile memory for long-term storage of information and may retain information after power on/off cycles. Examples of non-volatile memory may include flash memories or forms of electrically programmable memories (EPROM) or electrically erasable and programmable (EEPROM) memories.

Communication unit(s) 204 may enable hearing instrument 102A to send data to and receive data from one or more other devices, such as a device of computing system 106 (FIG. 1), another hearing instrument (e.g., hearing instrument 102B), an accessory device, a mobile device, or other types of device. Communication unit(s) 204 may enable hearing instrument 102A to use wireless or non-wireless communication technologies. For instance, communication unit(s) 204 enable hearing instrument 102A to communicate using one or more of various types of wireless technology, such as a BLUETOOTH™ technology, 3G, 4G, 4G LTE, 5G, ZigBee, WI-FI™, Near-Field Magnetic Induction (NFMI), ultrasonic communication, infrared (IR) communication, ultra-wideband (UWB), or another wireless communication technology. In some examples, communication unit(s) 204 may enable hearing instrument 102A to communicate using a cable-based technology, such as a Universal Serial Bus (USB) technology.

Receiver 206 includes one or more speakers for generating audible sound. In the example of FIG. 2, receiver 206 includes a speaker such as speaker 108A as illustrated in FIG. 1. The speakers of receiver 206 may generate sounds that include a range of frequencies. In some examples, the speakers of receiver 206 includes “woofers” and/or “tweeters” that provide additional frequency range.

Processor(s) 208 include processing circuits configured to perform various processing activities. Processor(s) 208 may process signals generated by microphone(s) 210 to enhance, amplify, or cancel-out particular channels within the incoming sound. Processor(s) 208 may then cause receiver 206 to generate sound based on the processed signals. In some examples, processor(s) 208 include one or more digital signal processors (DSPs). In some examples, processor(s) 208 may cause communication unit(s) 204 to transmit one or more of various types of data. For example, processor(s) 208 may cause communication unit(s) 204 to transmit data to computing system 106. Furthermore, communication unit(s) 204 may receive audio data from computing system 106 and processor(s) 208 may cause receiver 206 to output sound based on the audio data. In the example of FIG. 2, processor(s) 208 include processors 112A (FIG. 1). Processor(s) 208 may include processors similar to those of processors 112A in addition to one or more processors. In some examples, processors 208 may include only the processors of processors 112A. In other examples, processors 208 may include a portion of processors 112A in addition to other processors. In an example, processors 208 include the processors of processors 112A in addition to other processors.

Microphone(s) 238 detect incoming sound and generate one or more electrical signals (e.g., an analog or digital electrical signal) representing the incoming sound. In some examples, microphone(s) 238 include directional and/or omnidirectional microphones. Hearing instrument 102A may use microphone(s) 238 to detect incoming sound such as spoken voices and/or environmental sound.

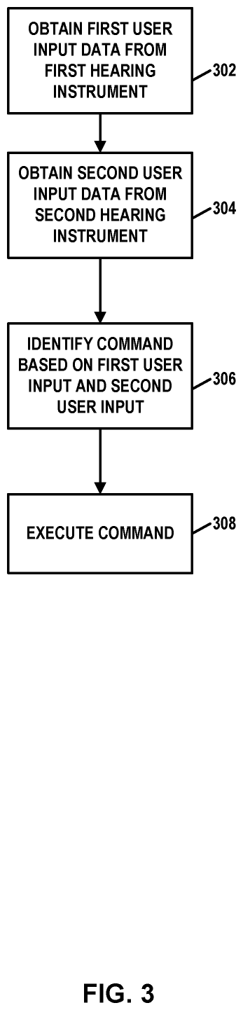

FIG. 3 is a flowchart illustrating an example operation in accordance with one or more techniques of this disclosure. Other examples of this disclosure may include more, fewer, or different action. In some examples, actions in the flowcharts of this disclosure may be performed in parallel or in different orders. For the purposes of clarity, FIG. 3 is described in the context of FIG. 1.

In the example of FIG. 3, the first hearing instrument of hearing instruments such as hearing instruments 102 obtains first user input via one or more sensors within the first hearing instrument (302). The first hearing instrument may obtain first user input such as input consistent with a user, such as user 104, pressing on the side of the first hearing instrument, tapping on the side of the first hearing instrument, and/or other types of input from user 104.

A second hearing instrument of hearing instruments 102 obtains second user input (304). The second hearing instrument may obtain second user input consistent with user 104 pressing on the side of the second hearing instrument, tapping on the side of the second hearing instrument, and/or other types of input from user 104.

Responsive to obtaining first user input data and second user input data, hearing instruments 102 identify a command associated with the obtained first user input data and second user input data (306). Hearing instruments 102 may identify a synchronous command such as changing the configuration of hearing instruments 102 (e.g., increasing or decreasing the volume), enabling or disabling functionality of hearing instruments 102 (e.g., activating or deactivating an active noise canceling mode), or another such change to the functionality of hearing instruments 102.

Responsive to identifying a synchronous command, hearing instruments 102 execute the command (308). Hearing instruments 102 may execute a command such as changing one or more settings of hearing instruments 102, enabling or disabling one or more modes of hearing instruments 102 (e.g., a noise cancelling mode), and/or executing other commands.

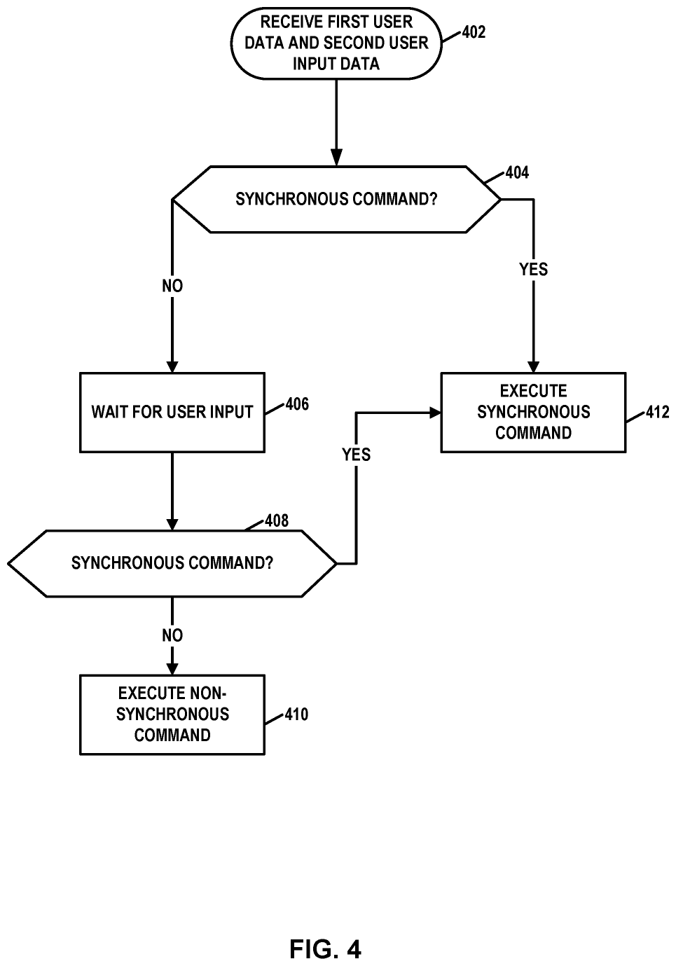

FIG. 4 is a flowchart illustrating an example operation in accordance with one or more techniques of this disclosure. Other examples of this disclosure may include more, fewer, or different actions. In some examples, actions in the flowcharts of this disclosure may be performed in parallel or in different orders. For the purposes of clarity, FIG. 4 is described in the context of FIG. 1.

In the example of FIG. 4, hearing instruments such as hearing instruments 102 receive first user input data and second user input data from one or more input sensors such as input sensors 110 (402). Hearing instruments 102 may receive user input from user 104 via one or more components such as input sensors 110. For example, hearing instruments 102 may receive first user input of user 104 tapping the side of hearing instrument 102B while receiving second user input of user 104 swiping on a touch-sensitive surface of hearing instrument 102A.

Responsive to the receipt of input data, hearing instruments 102 determine whether the received first user input and second user input are associated with a synchronous command (404). Hearing instruments 102 may be configured such that the first user input data and the second user input data is sent to and always processed by the same hearing instrument of hearing instruments 102 (e.g., hearing instrument 102A always processes synchronous inputs). Hearing instruments 102 may determine whether received first user input and second user input are associated with a synchronous command based one or more factors. For example, hearing instruments 102 may determine whether the received second user input was received within a predetermined period of time from the receipt of the received first user input. In another example, hearing instruments 102 determine whether the received first user input and second user input correspond to any commands for hearing instruments 102 (e.g., whether user 104 has provided user input that is recognizable as a command by hearing instruments 102).

Hearing instruments 102 may determine that a synchronous command has been received (“YES” branch of 404). Hearing instruments 102 may determine that a synchronous command has been received based on the received first user input and the second user input. In addition, hearing instruments 102 may determine the synchronous command that correlates to the received first user input and second user input. For example, hearing instruments 102 may determine that received user input of user 104 tapping on hearing instrument 102A while swiping on hearing instrument 102B correlates to a particular command.

Hearing instruments 102 then execute the synchronous command (412). Hearing instruments 102 may execute a synchronous command such as changing the configuration of hearing instruments 102 (e.g., increasing or decreasing the volume), enabling or disabling functionality of hearing instruments 102 (e.g., activating or deactivating an active noise canceling mode), or another such change to the functionality of hearing instruments 102. Hearing instruments 102 may execute a synchronous command that enables user 104 to access a menu. For example, hearing instruments 102 may provide auditory indicators of a menu in response to a synchronous command received from user 104.

Hearing instruments 102 may determine that a synchronous command has not been received (“NO” branch of 404). Hearing instruments 102 may determine that a synchronous command has not been received based on one or more factors. In an example, a first hearing instrument of hearing instruments 102 receives first user input but a second hearing instrument of hearing instrument 102 does not receive second user input. In an additional example, the second hearing instrument of hearing instruments 102 receives first user input but the first hearing instrument of hearing instruments 102 does not receive second user input.

Responsive to the determination that only one of hearing instruments 102 has received user input, hearing instruments 102 may wait a predefined period of time for further user input (406) . . . . In an example, hearing instruments 102 determine that a first hearing instrument has received user input but that a second hearing instrument has not received user input. Hearing instruments 102 wait a predetermined period of time for further user input to the second hearing instrument before determining whether a non-synchronous command was issued instead of a synchronous command. For example, hearing instruments 102 may wait a period of time to determine whether first input data and second input data have been received by the first hearing instrument and the second hearing instrument, respectively. Hearing instruments 102 may wait a period of time configured by user 104, set by the manufacturer of hearing instruments 102, and/or configured by a hearing instruments specialist.

Hearing instruments 102 determine whether a synchronous command was received by hearing instruments 102 (408). Hearing instruments 102 may determine whether a synchronous command was received in response to the period of time elapsing. Hearing instruments 102 may determine whether a synchronous command was received based one or more factors. For example, hearing instruments 102 may determine whether user input was received by both of hearing instruments 102 or by only one of hearing instruments 102. In another example, hearing instruments 102 may determine whether the received user input corresponds to any of the synchronous commands available to hearing instruments 102. Responsive to the determination that a synchronous command has been received (“YES branch of 408”), hearing instruments 102 execute the synchronous command (412). Hearing instruments 102 may execute a synchronous command in response to determining that a synchronous command has been received by hearing instruments 102. For example, hearing instruments 102 may execute a synchronous command that grants access to a configuration menu for user 104.

Hearing instruments 102 may determine that a synchronous command has not been received and only one of first user input or second user input has been received by hearing instruments 102 (“NO” branch of 408). For example, hearing instrument 102B receives user input consistent with user 104 having tapped the side of hearing instrument 102B while hearing instrument 102A does not receive any input.

Responsive to the determination that input has been received by only one of hearing instruments 102, receiving hearing instrument of hearing instruments 102 may cause both hearing instruments 102 execute a non-synchronous command (412). Hearing instruments 102 may identify a non-synchronous command associated with the input received by only one of hearing instruments 102. Hearing instruments 102 may identify a non-synchronous command that is a command that only require input to one of hearing instruments 102 has been received. For example, hearing instruments 102 may execute a non-synchronous command that includes hearing instruments 102 receiving input consistent with user 104 tapping once on the side of one of hearing instruments 102 to hang up a phone call. In another example, hearing instruments 102 determine that only one of third input data or fourth input data has been obtained from hearing instruments 102. Hearing instruments 102, responsive to the determination, identify a non-synchronous command based on the which of the third input data or the fourth user input that have been obtained, where the non-synchronous command is a second command where input from only one of the first hearing instrument of hearing instruments 102 and the second hearing instrument of hearing instruments 102 have been received. Responsive to the identification, hearing instruments 102 execute the non-synchronous command.

The following is a non-limiting list of examples according to one or more techniques of this disclosure.

A system comprising a first hearing instrument and a second hearing instrument, wherein the first and second hearing instruments are communicatively coupled, and processing system including in one or more of the first or second hearing instruments, the processing system include one or more processors implement in circuitry wherein the processing system is configured to obtain, from one or more sensors within the first hearing instrument, first input data from a user of the first hearing instrument and the second hearing instrument, obtain, from one or more sensors within the second hearing instrument, second input data from a user, identify a command based on the first user input data and the second user input data, and execute the command.

A method comprising obtaining, from one or more sensors within a first hearing instrument, first input data from a user of the first hearing instrument, obtaining, from one or more sensors within a second hearing instrument, second input data for the user of the first hearing instrument and the second hearing instrument, identifying, by the first hearing instrument and the second hearing instrument based on the first input data and the second input data, a command, and executing, by the first hearing instrument and second hearing instrument, the command.

A non-transitory computer-readable medium, configured to cause one or more processors to obtain, from one or more sensors within a first hearing instrument, first input data, obtain, from one or more sensors within a second hearing instrument, second input data, identify a command based on the first input data and the second input data, and execute the command.

In this disclosure, ordinal terms such as “first,” “second,” “third,” and so on, are not necessarily indicators of positions within an order, but rather may be used to distinguish different instances of the same thing. Examples provided in this disclosure may be used together, separately, or in various combinations. Furthermore, with respect to examples that involve personal data regarding a user, it may be required that such personal data only be used with the permission of the user.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processing circuits to retrieve instructions, code and/or data structures for implementation of the techniques described in this disclosure. A computer program product may include a computer-readable medium.

By way of example, and not limitation, such computer-readable storage media may include RAM, ROM, EEPROM, CD-ROM or other optical disk storage, magnetic disk storage, or other magnetic storage devices, flash memory, cache memory, or any other medium that can be used to store desired program code in the form of instructions or store data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used herein, includes compact disc (CD), laser disc, optical disc, digital versatile disc (DVD), and Blu-ray disc, where disks usually reproduce data magnetically, while discs reproduce data optically with lasers. Combinations of the above should also be included within the scope of computer-readable media.

Functionality described in this disclosure may be performed by fixed function and/or programmable processing circuitry. For instance, instructions may be executed by fixed function and/or programmable processing circuitry. Such processing circuitry may include one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules. Also, the techniques could be fully implemented in one or more circuits or logic elements. Processing circuits may be coupled to other components in various ways. For example, a processing circuit may be coupled to other components via an internal device interconnect, a wired or wireless network connection, or another communication medium.

The techniques of this disclosure may be implemented in a wide variety of devices or apparatuses, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperative hardware units, including one or more processors as described above, in conjunction with suitable software and/or firmware.

Various examples have been described. These and other examples are within the scope of the following claims.

What is claimed is:

1. A system comprising:
a first hearing instrument and a second hearing instrument, wherein the first and second hearing instruments are communicatively coupled; and
a processing system included in one or more of the first or second hearing instruments, the processing system including one or more processors implemented in circuitry, wherein the processing system is configured to:
obtain, from one or more sensors within the first hearing instrument, first input data from a user of the first hearing instrument and the second hearing instrument;
obtain, from one or more sensors within the second hearing instrument, second input data from the user;
identify a command based on the first input data and the second input data; and
execute the command.

2. The system of claim 1, wherein:
the first hearing instrument comprises a first touch responsive surface,
the second hearing instrument comprises a second touch responsive surface, and
the first input data represents the user pressing and holding the first touch responsive surface of the first hearing instrument and the second input data represents the user tapping the second touch responsive surface of the second hearing instrument.

3. The system of claim 1, wherein the command is a first command and the processing system is further configured to:
obtain third input data from the one or more sensors within the first hearing instrument;
determine that the user ceased interacting with the first hearing instrument before obtaining fourth input data from the one or more sensors within the second hearing instrument;
identify, based on the determination that the user ceased interacting with the first hearing instrument before obtaining the fourth input data, a second command; and
execute the second command.

4. The system of claim 1, wherein the processing system is further configured to determine whether a predetermined period of time has elapsed before identifying the command.

5. The system of claim 4, wherein:
the command is a first command,
the first input data and the second input data are data regarding previous synchronous input, and
the processing system is further configured to:
modify, based on the data regarding previous synchronous input, the predetermined period of time;
obtain, from the one or more sensors within the first hearing instrument, third input data from the user;
determine that the modified predetermined period of time has elapsed after obtaining the third input data and without obtaining fourth input data from the one or more sensors within the second hearing instrument; and
based on the determination that the modified predetermined period of time has elapsed after obtaining the third input data and without obtaining the fourth input data from the one or more sensors within the second hearing instrument, execute a second command.

6. The system of claim 1, wherein the command is a first command and the processing system is further configured to:
determine that only one of third input data or fourth input data has been obtained from the first and second hearing instruments;
identify a non-synchronous command based on which of the third input data or the fourth input data has been obtained, wherein the non-synchronous command is a second command where input data from only one of the first hearing instrument and the second hearing instrument has been obtained; and
execute the non-synchronous command.

7. The system of claim 1, wherein the first input data and the second input data are respectively consistent with the user pressing twice on the first hearing instrument and pressing twice on the second hearing instrument.

8. The system of claim 1, wherein the first input data and the second input data are respectively consistent with the user pressing and holding down on the first hearing instrument and the user tapping the second hearing instrument.

9. The system of claim 1, wherein at least one of the first input data and the second input data comprise data consistent with the user tilting their head.

10. The system of claim 1, wherein the first input data and the second input data respectively comprise input data consistent with the user pressing and holding down on the first hearing instrument and the user pressing and holding down on the second hearing instrument.

11. A method comprising:
obtaining, by a processing system, from one or more sensors within a first hearing instrument, first input data from a user;
obtaining, by the processing system, from one or more sensors within a second hearing instrument, second input data from the user, wherein the user uses the first hearing instrument and the second hearing instrument,
identifying, by the processing system, a command based on the first input data and the second input data;
executing, by the processing system, the command.

12. The method of claim 11, wherein:
the first hearing instrument comprises a first touch responsive surface,
the second hearing instrument comprises a second touch responsive surface, and
the first input data represents the user pressing and holding the first touch responsive surface of the first hearing instrument and the second input data represents the user tapping the second touch responsive surface of the second hearing instrument.

13. The method of claim 11, wherein the command is a first command, the method further comprising:
obtaining, by the processing system, third input data from the one or more sensors within the first hearing instrument;
determining, by the processing system, that the user has ceased interacting with the first hearing instrument before obtaining fourth input data from the one or more sensors within the second hearing instrument;
identifying, by the processing system, a second command; and
executing, by the first hearing instrument and the second hearing instrument, the second command.

14. The method of claim 11, wherein identifying the command comprises waiting, by the processing system, a period of time to determine whether the first input data and the second input data have been received by the first hearing instrument and the second hearing instrument, respectively.

15. The method of claim 11, wherein the first input data is consistent with the user pressing and holding the first hearing instrument and the second input data is consistent with the user tapping the second hearing instrument.

16. The method of claim 11, wherein the first input data is consistent with the user pressing and holding the first hearing instrument and the second input data is consistent with the user pressing and holding the second hearing instrument.

17. The method of claim 11, further comprising determining, by the processing system, whether a predetermined period of time has elapsed before identifying the command during which the first hearing instrument and the second hearing instrument wait before determining whether the command was given by the user.

18. The method of claim 17, wherein:
the command is a first command,
the first input data and the second input data are data regarding a previous synchronous input; and
the method further comprises:
modifying, by the processing system and based on the data regarding the previous synchronous input, the predetermined period of time;
obtaining, by the processing system and from the one or more sensors within the first hearing instrument, third input data from the user;
determining, by the processing system, that the modified predetermined period of time has elapsed after obtaining the third input data and without obtaining fourth input data from the one or more sensors within the second hearing instrument; and
based on the determining that the modified predetermined period of time has elapsed after obtaining the third input data and without obtaining further input data from the one or more sensors within the second hearing instrument, executing, by the processing system, a second command.

19. The method of claim 11, further comprising:
determining, by the processing system, that only one of third input data or fourth input data has been obtained from the first and second hearing instruments;
identifying, by the processing system, a non-synchronous command based on which of the third input data and the fourth input data that has been obtained, wherein the non-synchronous command is a second command where input from only one of the first hearing instrument and the second hearing instrument has been obtained; and
executing, by the processing system, the non-synchronous command.

20. A non-transitory computer-readable medium, configured to cause one or more processors to:
obtain, from one or more sensors within a first hearing instrument, first input data;
obtain, from one or more sensors within a second hearing instrument, second input data;
identify, a command based on the first input data and the second input data; and
execute the command.
